(19) United States
(12) Patent Application Publication
(10) Pub. No.: US 2025/0173275 A1
(43) Pub. Date: May 29, 2025

(54) STORAGE CONTROLLER, STORAGE DEVICE, AND STORAGE SYSTEM

(71) Applicant: SAMSUNG ELECTRONICS CO., LTD., Suwon-si (KR)

(72) Inventors: Donggil Kang, Suwon-si (KR); Minsik Oh, Suwon-si (KR); Kyungjune Cho, Suwon-si (KR); Kyungsik Um, Suwon-si (KR); Yoon Soo Kim, Suwon-si (KR); Jongmin Kim, Suwon-si (KR); MyungGwan Jeong, Suwon-si (KR)

(73) Assignee: SAMSUNG ELECTRONICS CO., LTD., Suwon-si (KR)

(21) Appl. No.: 18/827,162

(22) Filed: Sep. 6, 2024

(30) Foreign Application Priority Data
Nov. 28, 2023 (KR) 10-2023-0167881

(51) Int. Cl. G06F 12/126; G06F 12/0895

(52) U.S. Cl. CPC G06F 12/126; G06F 12/0895

(57) ABSTRACT

A storage controller includes a processor configured to input and output a command for data to an outside, a data memory configured to store the data as cache data, a tag memory configured to store a priority with respect to replacement of the cache data, and a cache controller configured to determine the priority based on a type of the command with respect to the data stored as the cache data and a sequence of the type.

### CROSS-REFERENCE TO RELATED APPLICATION

This application claims priority to Korean Patent Application No. 10-2023-0167881, filed in the Korean Intellectual Property Office on Nov. 28, 2023, the disclosure of which is incorporated by reference herein in its entirety.

### BACKGROUND

The present disclosure relates to a storage controller, a storage device, and a storage system.

Cache memory has fast input/output speed, but has small capacity. Since programmers cannot directly manipulate the cache, hit ratio is an indicator of cache memory performance, and since the capacity of cache memory is also small, the cache replacement policy is directly related to the performance of cache memory.

In general, Least Recently Usage (LRU) or Most Recently Usage (MRU) policies are used as cache replacement policies, and the policies operate regardless of the operating environment of the system, resulting in inefficient management of cache memory. There is a need to flexibly manage cache memory according to the operating situation of the system.

### SUMMARY

One or more embodiments of the present disclosure provide a storage controller including a cache memory that may improve the flexibility and hit ratio of a cache replacement policy by considering the state of cache data.

In addition, one or more embodiments of the present disclosure provide a storage controller including a cache memory that may improve the cache hit ratio by variably setting the priority according to the system state.

According to an aspect of an example embodiment, a storage controller includes: a processor configured to input and output a command for data to an outside; a data memory configured to store the data as cache data; a tag memory configured to store a priority with respect to replacement of the cache data; and a cache controller configured to determine the priority based on a type of the command with respect to the data stored as the cache data and a sequence of the type.

According to an aspect of an example embodiment, a storage device includes: a non-volatile memory device configured to store data; and a storage controller including a cache memory configured to: store cache data with respect to the data and a priority with respect to replacement of the cache data, and change at least a portion of a priority table determining the priority with respect to the cache data, based on an application executed by an external host device.

According to an aspect of an example embodiment, a storage system includes: a host device configured to execute an application and provide an input/output command with respect to data based on execution of the application; and a storage device including: a non-volatile memory device configured to store the data according to the input/output command; and a cache memory configured to: store the data as cache data, store a priority with respect to replacement of the cache data, and determine the priority based on the application, a type of the input/output command for the data stored as the cache data, and a sequence of the type.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a block diagram showing a storage device according to an embodiment;

FIG. 2 is a block diagram showing the FTL of FIG. 1;

FIG. 3 is a block diagram showing a cache memory according to an embodiment;

FIG. 4 is a drawing for explaining a priority table according to an embodiment;

FIG. 5 is a drawing for explaining a priority bitmap according to an embodiment;

FIG. 6 is a drawing for explaining a resistor array according to an embodiment;

FIG. 7 is a block diagram showing a non-volatile memory device according to an embodiment;

FIG. 8 is a drawing for explaining a 3-dimensional structure of a memory cell array according to an embodiment;

FIG. 9 and FIG. 10 are drawings for explaining an operation of a storage system according to an embodiment;

FIG. 11 to FIG. 13 are drawings for explaining an operation of a storage system according to an embodiment;

FIG. 14 is a drawing for explaining an operation of a storage system according to an embodiment;

FIG. 15 and FIG. 16 are drawings for explaining an operation of a storage system according to an embodiment;

FIG. 17 is a drawing for explaining a priority bitmap according to an embodiment;

FIG. 18 is a drawing for explaining a resistor array according to an embodiment;

FIG. 19 and FIG. 20 are drawings for explaining an operation of a storage system according to an embodiment;

FIG. 21 is a block diagram showing an SSD system applied with a storage device according to an embodiment;

FIG. 22 is a block diagram showing a data center applied with a storage device according to an embodiment; and

FIG. 23 is a block diagram showing an electronic system applied with a storage device according to an embodiment.

### DETAILED DESCRIPTION

Hereinafter, example embodiments of the present disclosure will be described in detail hereinafter with reference to the accompanying drawings. As those skilled in the art will realize, the described embodiments may be modified in various different ways, all without departing from the spirit or scope of the present disclosure.

The drawings and description are to be regarded as illustrative in nature and not restrictive. Like reference numerals designate like elements throughout the specification.

Size and thickness of each constituent element in the drawings are arbitrarily illustrated for better understanding and ease of description, the following embodiments are not limited thereto.

In addition, unless explicitly described to the contrary, the word “comprise”, and variations such as “comprises” or “comprising”, will be understood to imply the inclusion of stated elements but not the exclusion of any other elements.

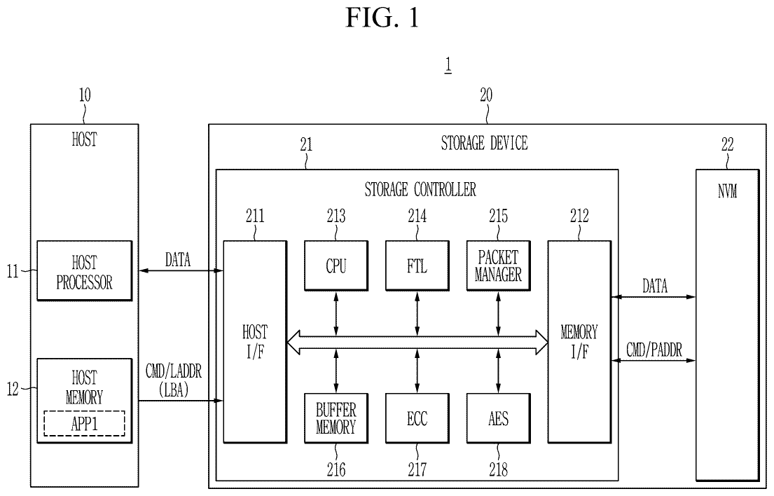

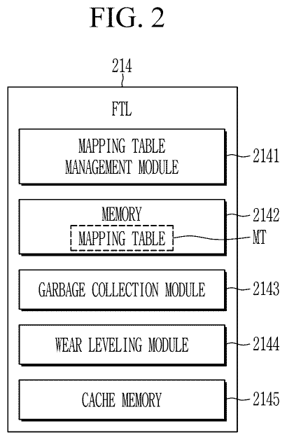

FIG. 1 is a block diagram showing a storage device according to an embodiment. FIG. 2 is a block diagram showing the FTL of FIG. 1.

Referring to FIG. 1 to FIG. 2, a storage system 1 may include a host device 10 and a storage device 20. The host device 10 may include a host processor 11 and a host memory 12. The storage device 20 may include a storage controller 21 and a non-volatile memory device (NVM) 22.

The storage system 1 may include at least one of various information processing devices such as a personal computer, a laptop computer, a server, a workstation, a smart phone, a tablet PC. Depending on the embodiment, the storage system 1 may include communication equipment, and may perform transmission and reception of signals due according to information processing with other devices outside the storage system 1.

Depending on the embodiment, the host processor 11 may operate as a processor to execute (process) a first application APP1, and the host memory 12 may operate as an operating memory such that the first application APP1 may be loaded on the host memory 12 and executed. Depending on the embodiment, the first application APP1 may be a video playback program, a document editing/viewer program, or the like, processed by the host device 10, but is not limited thereto.

An depending on the embodiment, the host processor 11 may execute and process commands, codes, files, image data, or the like, while processing the first application APP1 and may control the host device 10 to provide a command CMD and a logical address LADDR related to input/output of data DATA to the storage device 20, for data processing. The command CMD may include a data write command, a data read command, or the like. Depending on the embodiment, the logical address LADDR may be provided to the storage device 20 in the form of a logic block address LBA.

Depending on the embodiment, the host processor 11 may manage operations to store data (e.g., write data) in a buffer memory in a non-volatile memory device 22, or store data (e.g., read data) of the non-volatile memory device 22 in the buffer memory. In the storage operation management of the host processor 11, depending on the embodiment, the host memory 12 may function as a buffer memory for temporarily storing data to be transmitted to the storage device 20 or data transmitted from the storage device 20.

An depending on the embodiment, the host processor 11 and the host memory 12 may be implemented as separate semiconductor chips. In addition, in an embodiment, the host processor 11 and the host memory 12 may be integrated in the same semiconductor chip. As an example, the host processor 11 may be one among a plurality of modules provided in an application processor, and the application processor may be implemented as a system-on-chip (SOC). In addition, the host memory 12 may be an embedded memory provided within an application processor, or may be a non-volatile memory or memory module disposed outside the application processor.

The storage device 20 may include storage media for storing data according to the command CMD from the host device 10. For example, the storage device 20 may include at least one of a solid-state drive (SSD), an embedded memory, and a removable external memory. If the storage device 20 is an SSD, the storage device 20 may be, for example, a device that complies to the non-volatile memory express (NVMe) standard.

If the storage device 20 is an embedded memory or external memory, the storage device 20 may be a device that complies the universal flash storage (UFS) or embedded multi-media card (eMMC) standard. The host device 10 and the storage device 20 may each generate and transmit packets according to the adopted standard protocol.

When the non-volatile memory device 22 of the storage device 20 includes flash memory, such flash memory may include a 2D NAND memory array or a 3D (or Vertical) NAND (VNAND) memory array. As another example, the storage device 20 may include various other types of non-volatile memories. For example, the storage device 20 may include magnetic RAM (MRAM), spin-transfer torque MRAM, conductive bridging RAM (CBRAM), ferroelectric RAM (FeRAM), phase RAM (PRAM), resistive RAM and various other types of memories.

The storage controller 21 may control an overall operation of the non-volatile memory device 22, and provide the command CMD to the non-volatile memory device 22 to control a data read operation, a data write operation of the non-volatile memory device 22. The storage controller 21 may include a host interface 211, a memory interface 212. In addition, the storage controller 21 may include a processor 213, an FTL 214, a packet manager 215, a buffer memory 216, error correction code (ECC) engine 217, advanced encryption standard (AES) engine 218, or the like.

The storage controller 21 may further include an operating memory into which an operating system or a firmware executed by the processor 213 is loaded. Depending on the embodiment, the buffer memory 216 may operate as an operating memory of the processor 213, but is not limited thereto.

The host interface 211 may transmit and receive packets with the host device 10. The packet transmitted from the host device 10 to the host interface 211 may include the command CMD or data to be written to the non-volatile memory device 22, or the like, and the packet transmitted from the host interface 211 to the host device 10 may include a response to the command or the data DATA, or the like read from the non-volatile memory device 22.

The memory interface 212 may transmit the data DATA to be written in the non-volatile memory device 22 to the non-volatile memory device 22, or receive the data DATA read from the non-volatile memory device 22. The memory interface 212 may be implemented to comply with a standard protocol such as Toggle or ONFI.

The processor 213 may control an overall operation of respective components of the storage controller 21. The processor 213 may execute the firmware program or operation system embedded in the storage device 20, and may operate to provide the command CMD to the non-volatile memory device 22. A non-volatile memory device 220 may perform the data write operation and the data read operation with respect to the data DATA through the provided command CMD.

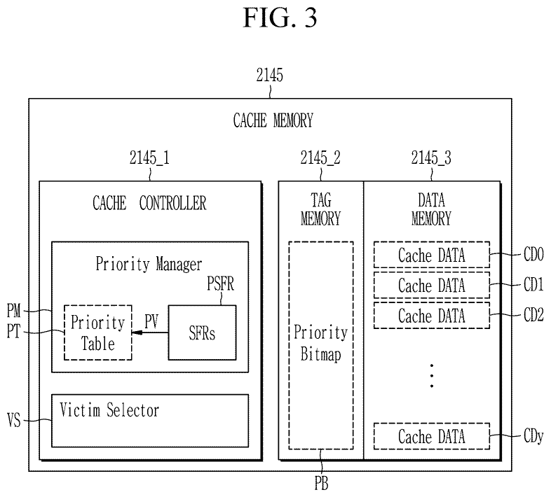

Depending on the embodiment, the processor 213 may provide a priority value PV to a plurality of priority special function registers (SFRs) PSFR within a cache controller 2145_1 of FIG. 3, depending on an operation situation of the host device 10. As an example, the processor 213 may change the priority value PV stored in a plurality of priority SFRs PSFR, depending on a change (e.g., process execution, front-/back-process switching, or the like) of the application processed in the host device 10.

Depending on the embodiment, the processor 213 may be implemented as various processing units, such as a central processing unit (CPU), an application processor (AP), a graphic processing unit (GPU), or the like, or a combination thereof.

The FTL 214 may include a mapping table management module 2141, a memory 2142 including a mapping table MT, a wear-leveling module 2144, a garbage collection module 2143, a cache memory 2145. The FTL 214 may perform various functions such as address mapping, wear-leveling, garbage collection through the above configurations.

Depending on the embodiment, the FTL 214 may be implemented as a hardware, a firmware, a software, and/or a combination thereof, and may be implemented as a dedicated circuit that performs the functions, but is not limited thereto.

The mapping table management module 2141 may perform an address mapping operation based on a mapping table MT. The address mapping operation is an operation of changing the logical address LADDR received from the host device 10 to a physical address PADDR used for actually storing the data DATA in the non-volatile memory device 22.

The mapping table management module 2141 may modify the mapping table MT loaded in the memory 2142 by reflecting a wear-leveling operation, and a garbage collection operation with respect to the non-volatile memory device 22. The mapping table MT may be implemented in the form of a lookup table, or the like, and depending on the embodiment, may include index, the logical address LADDR including a logical block address, and the physical address PADDR information, or the like. Depending on the embodiment, it may include erase counts of blocks or valid block information according to the operation results of the FTL 214.

Depending on the embodiment, the mapping table MT may be stored in a non-volatile memory embedded in the FTL 214 or a non-volatile memory embedded within the host device 10. The stored mapping table MT may be loaded in the memory 2142 by the mapping table management module 2141.

In the memory 2142, the mapping table MT may be loaded during the address mapping operation of the mapping table management module 2141. The memory 2142 may include at least one of various types of memory devices such as DRAM, SRAM, resistor, double data rate synchronous DRAM (DDR SDRAM), high-bandwidth memory (HBM), hybrid memory cube (HMC), dual in-line memory module (DIMM), Optane DIMM, or non-volatile DIMM (NVDIMM), or a combination thereof.

FIG. 2 illustrates that the memory 2142 is included in the FTL 214, but embodiments are not limited thereto. Depending on the embodiment, the host memory 12 and the buffer memory 216 of FIG. 1 may perform an operation of the memory 2142.

A garbage collection module 2143 may perform the garbage collection operation with respect to the non-volatile memory device 22. The garbage collection is a technology for securing usable capacity within the non-volatile memory device 22 through a method of copying valid data of a block to a new block and then erasing the original block.

The wear-leveling module 2144 may perform the wear-leveling operation with respect to the non-volatile memory device 22. The wear-leveling operation is a technology to prevent excessive degradation of a specific block by ensuring that blocks in the non-volatile memory device 22 are used uniformly, and may be implemented through firmware technology that balances erase counts of physical blocks.

The cache memory 2145 may operate as a buffer memory of the storage device 20, and may function as a buffer memory for temporarily storing the data DATA to be transmitted from the host device 10 to the storage device 20, the command CMD, the address LADDR, or the data DATA transmitted from the storage device 20. The specific configuration of the cache memory 2145 will be described later with reference to FIG. 3 to FIG. 6.

The packet manager 215 may generate packets according to the protocol of the interface negotiated with the host device 10, or parse various information from the packets received from the host device 10.

The buffer memory 216 may temporarily store the data DATA to be written in the non-volatile memory device 22 or the data DATA to be read from the non-volatile memory device 22. The buffer memory 216 may be provided within the storage controller 21, but depending on the embodiment, may be disposed outside the storage controller 21.

An ECC engine 217 may perform error detection and correction function with respect to a read data DATA read from the non-volatile memory device 22. For example, the ECC engine 217 may generate parity bits with respect to a write data to be written in the non-volatile memory device 22, and the parity bits generated as such may be stored within the non-volatile memory device 22 together with a write data DATA. When reading data from the non-volatile memory device 22, the ECC engine 217 may correct the error of the read data DATA by using parity bits read from the non-volatile memory device 22 together with the read data DATA, and output the read data DATA in which the error is corrected.

The AES engine 218 may perform at least one of encryption operation and decryption operation with respect to the data DATA input to the storage controller 21 by using a symmetric-key algorithm.

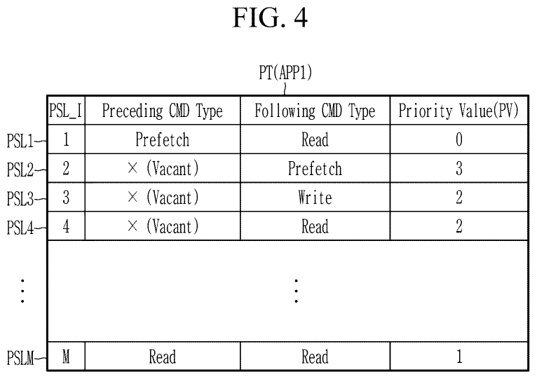

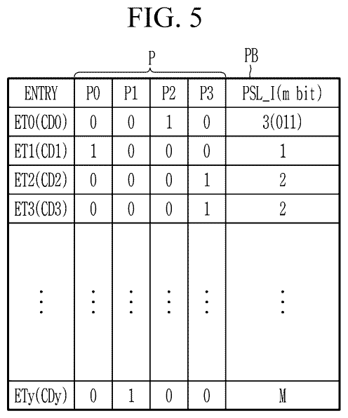

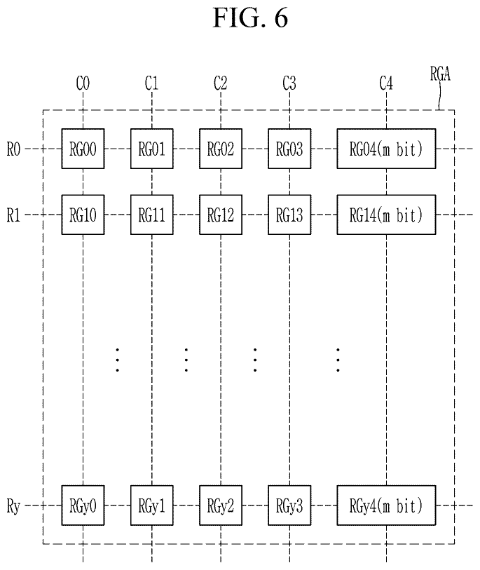

FIG. 3 is a block diagram showing a cache memory according to an embodiment. FIG. 4 is a drawing for explaining a priority table according to an embodiment. FIG. 5 is a drawing for explaining a priority bitmap according to an embodiment. FIG. 6 is a drawing for explaining a resistor array according to an embodiment.

Referring to FIG. 1 to FIG. 6, the cache memory 2145 may include the cache controller 2145_1, a tag memory 2145_2, and a data memory 2145_3.

The cache memory 2145 may store each of cache data CD0 to CDy and each tag information corresponding to the cache data CD0 to CDy, in the form of one entry, through the data memory 2145_3 and the tag memory 2145_2. Depending on the embodiment, the cache data CD0 to CDy may be data grouped in the form of cache blocks and cache lines in the data memory 2145_3, or data stored in page units.

The tag information may be stored in the tag memory 2145_2, and may be used for a search operation to determine whether the requested data DATA exists in the cache memory 2145. That is, tag information may be information for confirming whether the cache data CD0 to CDy are hit. Depending on the embodiment, tag information may correspond to an address, and the address may include a physical address, a logical address, or the like, but is not limited thereto.

The cache controller 2145_1 may control an overall operation of components of the cache memory 2145. The cache controller 2145_1 may perform the search operation for determining whether the data DATA requested from the host device 10 exists in the cache memory 2145, a replacement operation with respect to some cache data entries in order to store a new cache data while the data memory 2145_3 storing the cache data CD0 to CDy is full, an operation of determining the priority of each entry for the replacement operation, or the like. The cache controller 2145_1may include a configuration for processing the operation.

The cache controller 2145_1 may include a priority manager PM, and a victim cache selector VS. The priority manager PM may set and update a priority P with respect to replacement of the cache data CD0 to CDy stored in the data memory 2145_3.

The cache memory 2145 may store the cache data CD0 to CDy by a fully-associative method, and may perform replacement operation based on the priority P with respect to entire entries within the cache memory 2145, but embodiments are not limited thereto. Depending on the embodiment, the cache memory 2145 may store the cache data CD0 to CDy by a set-associative method, and may perform replacement operation based on the priority P with respect to partial entries corresponding to one set among entire entries within the cache memory 2145.

In the present disclosure, the priority P may be a state with respect to the hit ratio of the cache data within the cache memory 2145. Depending on the embodiment, a high priority may be set to cache data having a high hit ratio. Depending on the embodiment, cache data of low priority may be replaced first for efficient resource management of the cache memory 2145.

The priority manager PM may include a priority table PT and the plurality of priority SFRs PSFR. The priority manager PM may determine the priority P of each cache data based on the priority table PT and the plurality of priority SFRs PSFR, and may perform setting and updating operation with respect to the priority of each cache data.

Referring to FIG. 4, the priority table PT may include a plurality of priority setting lists PSL1 to PSLM (M is an integer of 2 or more) distinguished based on a type of a command for cache data and a sequence of the type of command. Each of the priority setting lists PSL1 to PSLM may include a setting index PSL_I corresponding to each of the priority setting lists PSL1 to PSLM, a type of a preceding command with respect to cache data, a type of a following command with respect to cache data, and the priority value PV corresponding to the type of the preceding command and the type of the following command. In the present disclosure, the following command may mean a command subsequently executed with respect to cache data cached by the preceding command. That is, the following command may mean a command at the hitting of the cache data, and the preceding command may mean a command before the hitting of the cache data.

Depending on the embodiment, the priority value PV corresponding to the type of the preceding command and the type of the following command may be changed according to the operation situation of the host device 10. As an example, the priority table PT may be changed, according to a change (e.g., process execution, front-/back-process switching, or the like) of the application processed in the host device 10. The priority table PT of FIG. 4 shows an example of priority values corresponding to the type of the preceding command and the type of the following command when the host device 10 executes the first application APP1.

The setting index PSL_I may be designated corresponding to each of the priority setting lists PSL1 to PSLM. When the priority table PT includes M priority setting lists, depending on the embodiment, the setting index PSL_I may include 1 to M, but embodiments are not limited thereto.

Depending on the embodiment, the preceding command and the following command may include the command CMD provided from the host device 10, the command CMD generated based on the command CMD provided from the host device 10 or generated within the storage controller 21 and provided to the non-volatile memory device 22, or the like.

As an example, when the host device 10 provides the data write command or the data read command, the storage controller 21 may perform a data input/output operation based on the data write command or the data read command and store the data that is the target of the input/output operation as cache data. In addition, when the host device 10 provides the data read command with respect to sequentially stored data, the storage controller 21 may provide a prefetch command with respect to data expected to be internally read to the non-volatile memory device 22 and may prefetch data expected to be read as cache data.

Depending on the embodiment, the preceding command and the type of the following command may be one of a read command, a write command, and the prefetch command, but the preceding command and the following command may include a partial read command, a partial write command, or the like. The type of the preceding command and the following command is a command that provokes caching operation of the cache memory 2145, and may be any command to access data stored in the storage device 20. The technical spirit and scope of the present disclosure are not limited to the example of the commands.

In addition, depending on the embodiment, the type of the preceding command may include vacant command. In the present disclosure, the case that the preceding command is a vacant command may mean the case that data that is not previously cached it registered in the cache memory 2145 as cache data.

Taking an example of FIG. 4, the priority table PT may include first to M-th the priority setting lists PSL1 to PSLM. A first priority setting list PSL1 may include the prefetch command as the preceding command, the read command as the following command, and 0, which is the priority value PV corresponding to ‘the prefetch command-read command’.

A second priority setting list PSL2 may include a vacant command as the preceding command, the prefetch command as the following command, and 3, which is the priority value PV corresponding to ‘vacant command-the prefetch command’. The prefetch command, which is the following command of the second priority setting list PSL2 may have the same type of command as the prefetch command, which is the preceding command of the first priority setting list PSL1. With an example of FIG. 4, with respect to the cache data of which the priority is set based on based on the second priority setting list PSL2, an operation due to the read command may be subsequently performed. In the above example, the priority of the cache data of which the priority is predetermined based on the second priority setting list PSL2 may be updated by the first priority setting list PSL1.

A third priority setting list PSL3 may include a vacant command as the preceding command, the write command as the following command, and 2, which is the priority value PV corresponding to ‘vacant command-the write command’.

A fourth priority setting list PSL4 may include a vacant command as the preceding command, the read command as the following command, and 2, which is the priority value PV corresponding to ‘vacant command-the read command’.

An M-th priority setting list PSLM may include the read command as the preceding command, the read command as the following command, and 1, which is the priority value PV corresponding to ‘the read command-the read command’. In the same way, the read command that is the following command of the fourth priority setting list PSL4 may have the same type of command as the read command that is the preceding command of the M-th priority setting list PSLM. With an example of FIG. 4, with respect to the cache data of which the priority is set based on the fourth priority setting list PSL4, an operation due to the read command may be subsequently performed. In the above example, the priority of the cache data of which the priority is predetermined based on the fourth priority setting list PSL4 may be updated by the M-th priority setting list PSLM.

In addition, based on the priority value PV stored in the plurality of priority SFRs PSFR, the priority value PV of the priority setting lists PSL1 to PSLM within the priority table PT may be set and changed. According to a change (e.g., process execution, front-/back-process switching, or the like) of the application processed in the host device 10, the processor 213 according to an embodiment may provide the priority value PV to the plurality of priority SFRs PSFR, and by reflecting the priority value PV stored in the plurality of priority SFRs PSFR, at least a portion of the priority table PT may be set or changed.

Depending on the embodiment, the number of the plurality of priority SFRs PSFR may correspond to M, which is the number of the priority setting lists PSL1 to PSLM within the priority table PT. The plurality of priority SFRs PSFR may include first to n-th priority SFRs to correspond to first to M-th the priority setting lists PSL1 to PSLM. Depending on the embodiment, one priority SFR may correspond to the priority value PV of one priority setting list, but embodiments are not limited thereto.

The victim cache selector VS may select cache data on which the replacement operation is to be performed. While the data memory 2145_3 is full, the victim cache selector VS may select and remove the entry of the cache data, in the sequence of the cache data with the lowest priority P.

For example, as shown in FIG. 5, when there are the priorities P of P0 to P3 states, the P0 state is the lowest priority, and the P3 state is the highest priority, the victim cache selector VS may first select and remove a first cache data CD1 and first priority entry ET1 of the P0 state.

Depending on the embodiment, the victim cache selector VS may remove cache data of the same priority in the order of entry of the cache data, i.e., in a round-robin method.

The tag memory 2145_2 may include a priority bitmap PB. The priority bitmap PB may include a plurality of priority entries ET0 to ETy. The plurality of priority entries ET0 to ETy may correspond to entries of a plurality of cache memory CD0 to CDy.

Depending on the embodiment, the number of priority entries ET0 to ETy within the priority bitmap PB may be equal to the number of entries that can be stored in the tag memory 2145_2 and the data memory 2145_3. According to the operation of the cache memory 2145, the number of each of the plurality of priority entries ET0 to ETy may be larger than the number of the cache data, a but while the data memory 2145_3 is full, the number of each of the plurality of priority entries ET0 to ETy and the number of the cache data may be identical.

Each of the priority entries ET0 to ETy may include the priority P with respect to each of the corresponding cache data CD0 to CDy and the setting index PSL_I.

While the data memory 2145_3 is full, the priority P may be used to perform replacement operation with respect to some entries in order to store (register) the new cache data. For example, in the order of lowest priority P of cache data, entries of cache data may be removed from the cache memory 2145 by the victim cache selector VS.

Each of the setting index PSL_I may become a basis of setting or updating respect to each of the priority P of the priority entries ET0 to ETy, and may correspond to the setting index PSL_I of the priority setting lists PSL1 to PSLM. Depending on the embodiment, when the priority value PV is changed according to a change of operation situation of the host device 10 or the cache data is hit, the setting index PSL_I may be used in an update operation of the priority P. Depending on the embodiment, the setting index PSL_I may be used in a remove operation by the victim cache selector VS.

The setting index PSL_I may be represented by m bits (m is an integer of 2 or more), and depending on the embodiment, the relationship between the number M of the priority setting lists PSL1 to PSLM and the number m of bits of the setting index PSL_I may be expressed by Equation 1 below.

M=2^{m} (Equation 1)

In Equation 1, M is the number of priority setting lists in the priority table PT, and m is the number of bits representing the setting index PSL_I.

Taking an example of FIG. 5, the priority P for each of the priority entries ET0 to ETy may be one of P0, P1, P2, and the P3 states, and depending on the embodiment, the priority becomes higher from the P0 state to the P3 state, and the priority may become lower from the P3 state to the P0 state. That is, the closer the cache data is to the P0 state, to sooner it may be replaced in order to store the new cache data. The order of replacement operation with respect to the P0, P1, P2, and the P3 states is merely an example, and the replacement sequence according to the P0, P1, P2, and the P3 states may depend on the embodiment.

A 0-th priority entry ET0 may correspond to a 0-th cache data CD0, and the priority P for the 0-th priority entry ET0 may be the P2 state, and the setting index PSL_I may be 3. Depending on the embodiment, the priority P of the 0-th cache data CD0 may be initially set by the third priority setting list PSL3.

The first priority entry ET1 may correspond to the first cache data CD1, and the priority P for the first priority entry ET1 may be the P0 state, and the setting index PSL_I may be 1. Depending on the embodiment, the priority P of the first cache data CD1 may be update by the first priority setting list PSL1.

A second priority entry ET2 may correspond to a second cache data CD2, and the priority P for the second priority entry ET2 may be the P3 state, and the setting index PSL_I may be 2. Depending on the embodiment, the priority P of the second cache data CD2 may be initially set by the third priority setting list PSL3.

A third priority entry ET3 may correspond to a third cache data CD3, and the priority P for the third priority entry ET3 may be the P3 state, and the setting index PSL_I may be 2. Depending on the embodiment, the priority P of the third cache data CD3 may be initially set by the third priority setting list PSL3.

A y-th priority entry ETy may correspond to a y-th cache data CDy, and the priority P for the y-th priority entry ETy may be the P1 state, and the setting index PSL_I may be M. Depending on the embodiment, the priority P of the y-th cache data CDy may be set by the M-th priority setting list PSLM.

FIG. 5 illustrates that the number of states of the priority P is 4, but embodiments are is not limited thereto, and may vary depending on the embodiment. In FIG. 5, the priority P is expressed through a flag bit of 1 bit representing each of the P0, P1, P2, and the P3 states, depending on the embodiment, the priority P may be represented by an index or a number through multiple bits.

Each of the P0, P1, P2, and the P3 states may correspond to the priority value PV of the priority table PT, may correspond to the priority value PV 0 when the priority P is the P0 state, may correspond to the priority value PV 1 when the priority P is the P1 state, may correspond to the priority value PV 2 when the priority P is the P2 state, and may correspond to the priority value PV 3 when the priority P is the P3 state.

In the present disclosure, the priority manager PM may improve the flexibility and hit ratio of a cache replacement policy by comprehensively consider the state of cache data, by determining and storing the priority with respect to the cache data, through the above priority setting lists PSL1 to PSLM distinguished based on the type of command and the sequence of the type of command.

In the present disclosure, the priority manager PM may optimize the cache hit ratio with respect to the user data according to the system operating state, by variably setting the priority of cache data according to the operation situation of the host device 10.

Referring to FIG. 6, the tag memory 2145_2 may store the priority bitmap PB through a resistor array RGA.

The resistor array RGA may include a plurality of resistors RG00 to RGy4 disposed along a plurality of rows R0 to Ry and a plurality of columns C0 to C4.

Each of the plurality of rows R0 to Ry may correspond to each of the priority entries ET0 to ETy within the priority bitmap PB. Each of the plurality of rows R0 to Ry may correspond to the priority P and the setting index PSL_I with respect to each of the cache data CD0 to CDy. As an example, 0_0-th to 0_3-th resistors RG00 to RG03 disposed in a 0-th row may store the priority P of the 0-th cache data CD0, and 0_4-th resistor RG04 may store the setting index PSL_I of m bits with respect to the 0-th cache data CD0.

th to third columns C0 to C3 among the plurality of columns C0 to C4 may correspond to whether the priority P corresponds to the P0, P1, P2, and the P3 states, and a fourth column C4 may correspond to the setting index PSL_I. As an example, 0_0-th to y_0-th resistors RG00 to RGy0 disposed in the 0-th column C0 may store whether each of the cache data CD0 to CDy is in the P0 state. 0_1-th to y_1-th resistors RG01 to RGy1 disposed in a first column C1 may store whether each of the cache data CD0 to CDy is in the P1 state, 0_2-th to y_2-th resistors RG02 to RGy2 disposed in a second column C2 may store whether each of the cache data CD0 to CDy is in the P2 state, and 0_3-th to y_3-th resistors RG03 to RGy3 disposed in a third column C3 may store whether each of the cache data CD0 to CDy is in the P3 state.

In the same way, 0_4-th to y_4-th resistors RG04 to RGy4 disposed in the fourth column C4 may store the setting index PSL_I of m bits with respect to each of the cache data CD0 to CDy.

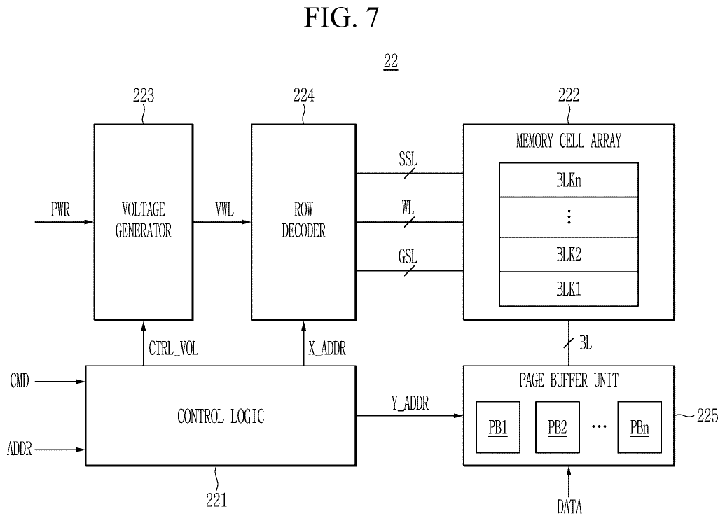

FIG. 7 is a block diagram showing a non-volatile memory device according to an embodiment.

Referring to FIG. 7, the non-volatile memory device 22 may include a control logic circuit 221, a memory cell array 222, a page buffer unit 225, a voltage generator 223, and a row decoder 224. The non-volatile memory device 220 may further include a memory interface 212 shown in FIG. 1, and may further include a column logic, a pre-decoder, a temperature sensor, a command decoder, an address decoder, or the like.

The control logic circuit 221 may generally control various operations within the non-volatile memory device 22. The control logic circuit 221 may output various control signals in response to the command CMD and/or address ADDR from the memory interface 212 (refer to FIG. 1). For example, the control logic circuit 221 may output a voltage control signal CTRL_vol, a row address X-ADDR, and a column address Y-ADDR.

The memory cell array 222 may include a plurality of memory blocks BLK1, BLK2, . . . BLKn, and the plurality of memory blocks BLK1 to BLKn each may include plurality of memory cells. The memory cell array 222 may be connected to the page buffer unit 225 through a bit line BL, and wordline WL, a string selection line SSL, and may be connected to the row decoder 224 through a ground selection line GSL.

In an embodiment, the memory cell array 222 may include 3-dimensional memory cell array, and 3-dimensional memory cell array may include a plurality of NAND strings. Each NAND string may include memory cells connected to wordlines vertically stacked on a substrate, respectively. In an embodiment, the memory cell array 222 may include 2-dimension memory cell array, and the 2-dimension memory cell array may include a plurality of NAND strings disposed along row and column directions.

The page buffer unit 225 may include a plurality of page buffers PB1 to PBn (n is an integer of 3 or more), and the plurality of page buffers PB1 to PBn may be respectively connected memory cells through a plurality of bit line BL. The page buffer unit 225 may select at least one bit line among the bit lines BL in response to the column address Y-ADDR. The page buffer unit 225 may operate as a write driver or detection amplifier depending on the operation mode. For example, during a program operation, the page buffer unit 225 may apply a bit line voltage corresponding to data to be programmed to the selected bit line. During the read operation, the page buffer unit 225 may detect data stored in a memory cell by detecting the current or voltage of the selected bit line.

The voltage generator 223 may generate various types of voltages to perform program, read, and erase operations based on the voltage control signal CTRL_vol. For example, the voltage generator 223 may generate a program voltage, a read voltage, a program verification voltage, an erase voltage, or the like as a wordline voltage VWL.

The row decoder 224 may select one among a plurality of wordlines WL in response to the row address X-ADDR, and may select one among a plurality of string selection lines SSL. For example, during a program operation, the row decoder 224 may apply the program voltage and the program verification voltage to the selected wordline, and during the read operation, may apply the read voltage to selected wordline.

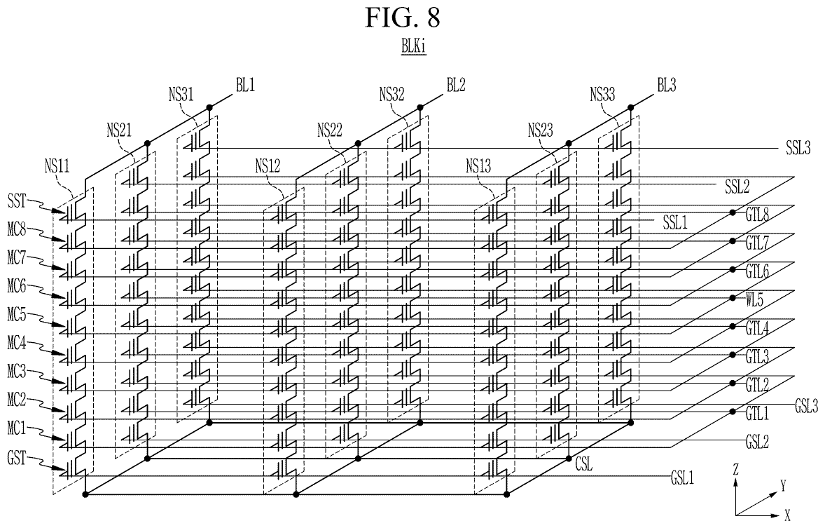

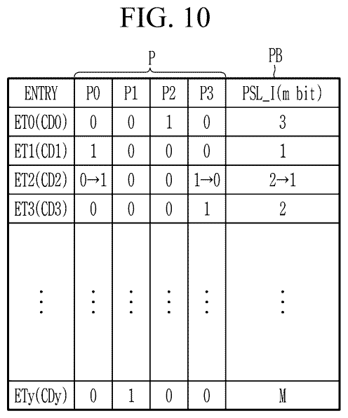

FIG. 8 is a drawing for explaining a 3-dimensional structure of a memory cell array according to an embodiment. When the non-volatile memory device 22 according to an embodiment is implemented as a flash memory of the 3D V-NAND type, each of the plurality of memory blocks configuring the storage module may be expressed as an equivalent circuit shown in FIG. 10.

A memory block BLKi shown in FIG. 8 represents a 3-dimensional memory block formed in a 3-dimensional structure on a substrate. For example, a plurality of memory NAND strings included in the memory block BLKi may be formed in a direction perpendicular to the substrate.

Referring to FIG. 8, the memory block BLKi may include a plurality of memory NAND strings NS11 to NS33 connected between bit lines BL1, BL2, and BL3 and a common source line CSL. Each of the plurality of memory NAND strings NS11 to NS33 may include string select transistor SST, a plurality of memory cells MC1, MC2, . . . , and MC8 and ground select transistor GST. FIG. 8 illustrates that each of the plurality of memory NAND strings NS11 to NS33 includes eight memory cells MC1, MC2, . . . , and MC8, but it is not necessarily limited thereto.

The string select transistor SST may be connected to corresponding string selection lines SSL1, SSL2, and SSL3. The plurality of memory cells MC1, MC2, . . . , and MC8 may be connected to corresponding gate lines GTL1, GTL2, . . . , and GTL8, respectively. The gate lines GTL1, GTL2, . . . , and GTL8 may correspond to wordlines, and a portion of the gate lines GTL1, GTL2, . . . , and GTL8 may correspond to dummy wordline. The ground select transistor GST may be connected to corresponding the ground selection line GSL1, GSL2, and GSL3. The string select transistor SST may be connected to corresponding the bit lines BL1, BL2, and BL3, and the ground select transistor GST may be connected to the common source line CSL.

Wordlines (e.g., WL1) of the same height may be connected in common, and the ground selection line GSL1, GSL2, and GSL3 and the string selection lines SSL1, SSL2, and SSL3 may be separated from each other. FIG. 8 illustrates that the memory block BLK is connected to eight gate lines GTL1, GTL2, . . . , and GTL8 and three the bit lines BL1, BL2, and BL3, but it is not necessarily limited thereto.

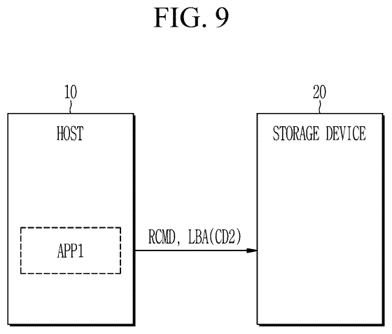

FIG. 9 and FIG. 10 are drawings for explaining an operation of a storage system according to an embodiment. FIG. 9 and FIG. 10 are drawings for explaining that the cache memory 2145 updates the priority P in the cache data hit situation, assuming the priority table PT of FIG. 4 and the priority bitmap PB of FIG. 5.

Referring to FIG. 1 to FIG. 5, FIG. 9 and FIG. 10, during execution of the first application APP1, the host device 10 may provide the logical block address LBA and a read a command RCMD corresponding to the second cache data CD2 to the storage device 20.

The priority manager PM may confirm the preceding command corresponding to the cache data hit situation based on the setting index PSL_I of the cache data. In addition, the priority manager PM may search a priority setting list corresponding to the cache data hit situation, based on the setting index PSL_I of the cache data and the command of the cache data.

The priority manager PM may check the setting index PSL_I with respect to the second cache data CD2 through the second priority entry ET2 with respect to the second cache data CD2. The priority manager PM may confirm the preceding command prior to the read command RCMD with respect to the second cache data CD2 through the following command of the second priority setting list PSL2 corresponding to the case where the setting index PSL_I is ‘2’.

The priority manager PM may confirm the prefetch command as the preceding command prior to the read command RCMD with respect to the second cache data CD2. As the storage device 20 receives the read command RCMD with respect to the second cache data CD2, the priority manager PM may determine and update the priority P and the setting index PSL_I with respect to the second cache data CD2 based on the second priority setting list PSL2.

As the priority manager PM receives the read command RCMD with respect to the second cache data CD2, the priority manager PM may update each of the priority P and the setting index PSL_I to P0 and 1, respectively, based on the setting index PSL_I and the second priority setting list PSL2 corresponding to 2.

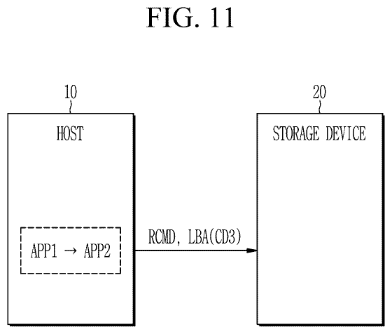

FIG. 11 to FIG. 13 are drawings for explaining the operation of a storage system according to an embodiment. FIGS. 11 to 13 are drawings for explaining that the cache memory 2145 updates the priority P in the situation that the operation situation of the host device 10 is changed and the cache data is hit, assuming the priority table PT of FIG. 4 and the priority bitmap PB of FIG. 5.

Referring to FIG. 1 to FIG. 5, and FIG. 11 to FIG. 13, the program processed by the host device 10 may be changed from the first application APP1 to a second application APP2. The change may include that the host device 10 finishes execution of the first application APP1 and starts execution of the second application APP2. In addition, it may include that the second application APP2 is front-processed while switching the first application APP1 that is front-processed to a back-process.

In the same way as in the first application APP1, the second application APP2 may also be a video playback program, a document editing/viewer program, or the like, which is processed by the host device 10, but embodiments are not limited thereto.

The logical block address LBA and the read command RCMD corresponding to the third cache data CD3 may be provided to the storage device 20.

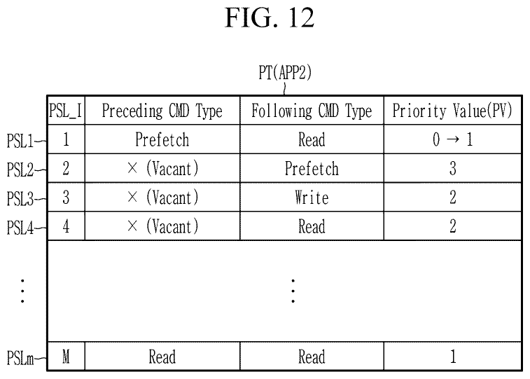

In response to the process with respect to the second application APP2 of the host device 10, the processor 213 may change the priority value PV stored in at least a portion of the plurality of priority SFRs. Taking an example of FIG. 12, in response to the process with respect to the second application APP2 of the host device 10, the processor 213 may change the priority value PV stored in the SFR corresponding to the first priority setting list PSL1. Accordingly, the priority value PV of the first priority setting list PSL1 may be changed from 0 to 1.

During execution of the second application APP2, the host device 10 may provide the logical block address LBA and the read command RCMD corresponding to the third cache data CD3 to the storage device 20.

The priority manager PM may confirm the preceding command corresponding to the cache data hit situation based on the setting index PSL_I of the cache data. In addition, the priority manager PM may search a priority setting list corresponding to the cache data hit situation, based on the setting index PSL_I of the cache data and the command of the cache data.

The priority manager PM may check the setting index PSL_I with respect to the third cache data CD3 through the third priority entry ET3 with respect to the third cache data CD3. The priority manager PM may confirm the preceding command prior to the read command RCMD with respect to the third cache data CD3, through the following command of the second priority setting list PSL2 corresponding to the case where the setting index PSL_I is ‘2’.

The priority manager PM may confirm the prefetch command as the preceding command prior to the read command RCMD with respect to the third cache data CD3. The storage device 20 may receive the read command RCMD with respect to the third cache data CD3. In correspond to the reception, the priority manager PM may determine and update the priority P and the setting index PSL_I with respect to the third cache data CD3, based on the first priority setting list PSL1 where the preceding command and the following command correspond to ‘the prefetch command-read command’.

As the storage device 20 receives the read command RCMD with respect to the third cache data CD3, the priority manager PM may update each of the priority P and the setting index PSL_I to ‘P1’ and ‘1’, respectively, based on the setting index PSL_I and the first priority setting list PSL1 corresponding to 2.

Depending on the embodiment, for cache data that was not hit, the priority manager PM may maintain the priority P even if at least a portion of the priority value PV within the priority table PT is changed.

The priority manager PM may maintain the priority P of the first priority entry ET1 at ‘P0’, with respect to the first cache data CD1 that was not hit.

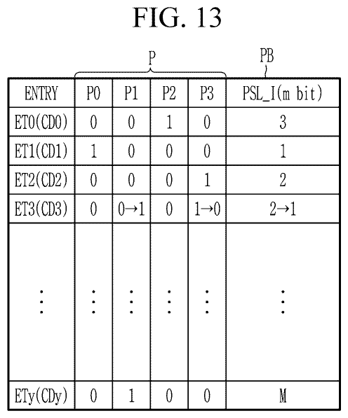

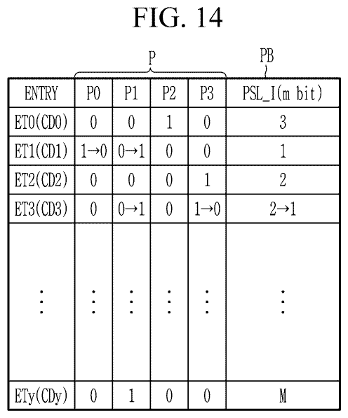

FIG. 14 is a drawing for explaining the operation of a storage system according to an embodiment. FIG. 14 is a drawing corresponding to FIG. 13, and for ease of explanation, the operation in FIG. 14 will be described focusing on the differences from the operation in FIG. 13.

Referring to FIG. 1 to FIG. 5, FIG. 11 to FIG. 12, and FIG. 14, according to the priority value PV change of the first priority setting list PSL1, the priority manager PM may change the priority P of a priority entry whose setting index PSL_I is 1.

The priority manager PM may update the priority P with respect to the first cache data CD1 of the first priority entry ET1 from ‘P0’ to ‘P1’.

Depending on the embodiment, even with respect to cache data that was not hit, the priority manager PM may update the priority P, in response to the changed priority value PV in the priority table PT.

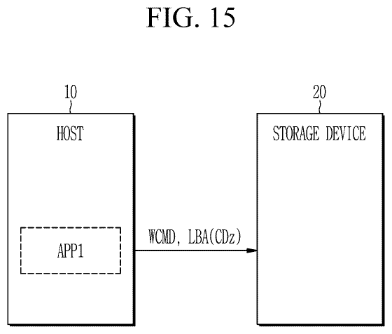

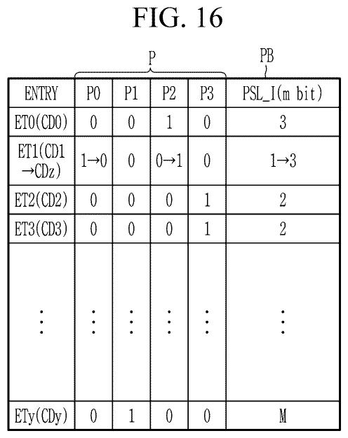

FIG. 15 and FIG. 16 are drawings for explaining the operation of a storage system according to an embodiment. Assuming the priority table PT of FIG. 4 and the priority bitmap PB of FIG. 5, FIGS. 15 to 16 are drawings for explaining replacement operation with respect to entries of some cache data in order to store the new cache data, while the data memory 2145_3 is full.

Referring to FIG. 1 to FIG. 5, FIG. 15 and FIG. 16, during execution of the first application APP1, the host device 10 may provide data, the logical block address LBA, and the write command WCMD corresponding to a z-th cache data CDz to be newly stored in the storage device 20.

The data memory 2145_3 may be provided with the z-th cache data CDz as the new cache data, while being full with 0-th to y-th the cache data CD0 to CDy.

The victim cache selector VS may select a priority entry from among 0-th to y-th the priority entries ET0 to ETy based on the priority P, and remove cache data corresponding to the selected priority entry. After the remove operation, new cache data and tag information and priority corresponding thereto may be stored in the cache memory 2145.

The victim cache selector VS may select and remove the first priority entry ET1 whose priority P is P0 from among the 0-th to y-th the priority entries ET0 to ETy. The z-th cache data CDz instead of the first cache data CD1 may be newly stored in the data memory 2145_3, and the priority P and setting index S with respect to the z-th cache data CDz may be initially set in the first priority entry ET1 of the priority table PT.

Referring to FIG. 4, since the z-th cache data CDz is newly stored as the write command WCMD, the priority P and the setting index PSL_I of the first priority entry ET1 may be initially set, by being replaced with ‘P2’ and ‘3’, based on the third priority setting list PSL3.

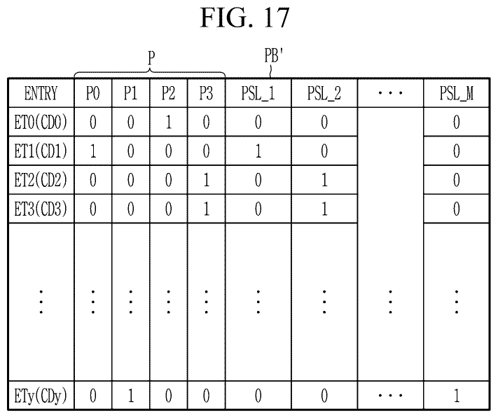

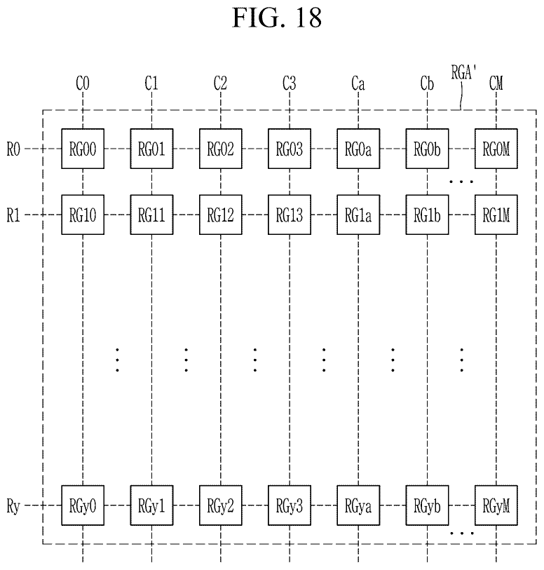

FIG. 17 is a drawing for explaining a priority bitmap according to an embodiment. FIG. 18 is a drawing for explaining a resistor array according to an embodiment. A priority bitmap PB′ of FIG. 17 may correspond to the priority bitmap PB of FIG. 5, and the resistor array RGA′ of FIG. 18 may correspond to the resistor array RGA of FIG. 6. For ease of description, FIG. 17 and FIG. 18 will be described focusing on the difference from the description of FIG. 5 and FIG. 6. Hereinafter, in description of FIG. 17 and FIG. 18, the same content as the cache memory 2145 of FIG. 5 and FIG. 6 will be omitted.

Referring to FIG. 1 to FIG. 4, FIG. 17 and FIG. 18, each of the plurality of priority entries ET0 to ETy of the priority bitmap PB′ may include flag bits of 1 bit representing individual correspondences PSL_1 to PSL_M of the priority setting lists PSL1 to PSLM of the cache data, instead of the setting index. The correspondence means that the priority P of cache data is set or updated based on the corresponding priority setting list.

As an example, the 0-th priority entry ET0 may include the flag bit of 1 bit representing a first priority setting list correspondence PSL_1 of the 0-th cache data CD0, the flag bit of 1 bit representing a second priority setting list correspondence PSL_2 of the 0-th cache data CD0, and the flag bit of 1 bit representing an M-th priority setting list correspondence PSL_M of the 0-th cache data CD0, or the like, as well as the priority P. It may be seen that, through the 0-th priority entry ET0, the priority P of the 0-th cache data CD0 is set or updated by a priority setting list other than the first priority setting list PSL1, the second priority setting list PSL2, and second priority setting list PSLM.

The first priority entry ET1 may include the flag bit of 1 bit representing the first priority setting list correspondence PSL_1 of the first cache data CD1, the second priority setting list correspondence PSL_2 of the first cache data CD1, and the flag bit of 1 bit representing the M-th priority setting list correspondence PSL_M of the first cache data CD1, or the like, as well as the priority P. It may be seen that, through the first priority entry ET1, the priority P of the first cache data CD1 is set or updated by the first priority setting list PSL1.

The second priority entry ET2 may include the flag bit of 1 bit representing the first priority setting list correspondence PSL_1 of the second cache data CD2, the flag bit of 1 bit representing the second priority setting list correspondence PSL_2 of the second cache data CD2, and the flag bit of 1 bit representing the M-th priority setting list correspondence PSL_M of the second cache data CD2, or the like, as well as the priority P. It may be seen that, through the second priority entry ET2, the priority P of the second cache data CD2 is set or updated by the second priority setting list PSL2.

The third priority entry ET3 may include the flag bit of 1 bit representing the first priority setting list correspondence PSL_1 of the third cache data CD3, the flag bit of 1 bit representing the second priority setting list correspondence PSL_2 of the third cache data CD3, and the flag bit of 1 bit representing the M-th priority setting list correspondence PSL_M of the third cache data CD3, or the like, as well as the priority P. It may be seen that, through the third priority entry ET3, the priority P of the third cache data CD3 is set or updated by the second priority setting list PSL2.

The y-th priority entry ETy may include the flag bit of 1 bit representing the first priority setting list correspondence PSL_1 of the y-th cache data CDy, the flag bit of 1 bit representing the second priority setting list correspondence PSL_2 of the y-th cache data CDy, and the flag bit of 1 bit representing the M-th priority setting list correspondence PSL_M of the y-th cache data CDy, or the like, as well as the priority P. It may be seen that, through the y-th priority entry ETy, the priority P of the y-th cache data CDy is set or updated by the M-th priority setting list PSLM.

The tag memory 2145_2 may store the priority bitmap PB′ through the resistor array RGA′. The resistor array RGA′ may include a plurality of resistors RG00 to RGyM disposed along the plurality of rows R0 to Ry and a plurality of columns C0-C3 and Ca-CM.

Each of the plurality of rows R0 to Ry may correspond to each of the priority entries ET0 to ETy within the priority bitmap PB′. Each of the plurality of rows R0 to Ry may correspond to flag bits of 1 bit representing the priority P with respect to each of the cache data CD0 to CDy and individual priority setting list correspondences PSL_1 to PSL_M of each of the cache data CD0 to CDy. As an example, each of 0_a-th to 0_M-th resistors RG0a to RG0M disposed in a 0-th row R0 may correspond to flag bits of 1 bit representing individual priority setting list correspondences PSL_1 to PSL_M with respect to the 0-th cache data CD0.

One column among a-th to M-th columns Ca to CM may correspond to flag bits of 1 bit representing correspondence with respect to one of the plurality of priority setting lists PSL1 to PSLM of the cache data CD0 to CDy.

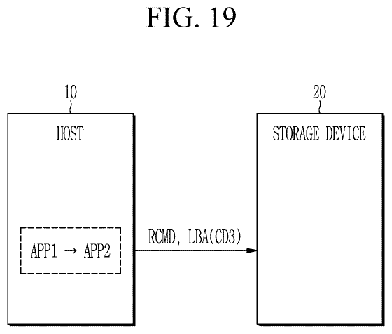

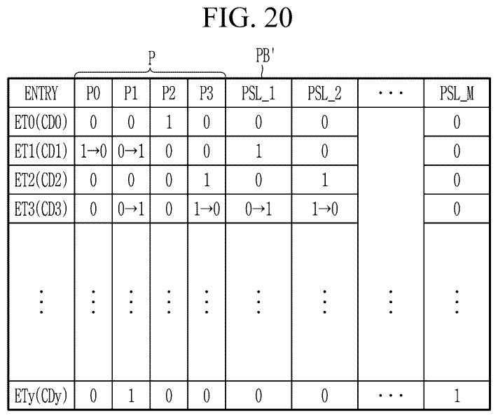

FIG. 19 and FIG. 20 are drawings for explaining the operation of a storage system according to an embodiment. FIGS. 19 to 29 are drawings for explaining that, as the operation situation of the host device 10 changes, at least a portion of the priority table PT is changed and the cache memory 2145 updates the priority P in the cache data hit situation as shown in FIG. 12, assuming the priority table PT of FIG. 4 and the priority bitmap PB′ of FIG. 17.

FIG. 11 and FIG. 13 may correspond to FIG. 19 and FIG. 20, respectively. For ease of description, the following description will be focused on differences from the description of FIG. 11 and FIG. 13. Hereinafter, the same contents as the description of FIG. 11 to FIG. 13 will be omitted.

Referring to FIG. 1 to FIG. 4, FIG. 12, FIG. 17, FIG. 19 and FIG. 20, as the program processed by the host device 10 is changed from the first application APP1 to the second application APP2, the priority value PV of the first priority setting list PSL1 may be changed from 0 to 1.

During execution of the second application APP2, the host device 10 may provide the logical block address LBA and the read command RCMD corresponding to the third cache data CD3 to the storage device 20.

The priority manager PM may confirm the preceding command corresponding to the cache data hit situation based on flag bits of 1 bit representing the individual correspondences PSL_1 to PSL_M of the priority setting lists PSL1 to PSLM. In addition, the priority manager PM may search a priority setting list corresponding to the cache data hit situation, based on the flag bit and the command of the cache data.

The priority manager PM may check flag bits representing the priority setting list correspondences PSL_1 to PSL_M with respect to the third cache data CD3 through the third priority entry ET3. Through the fact that the flag bit representing the second priority setting list correspondence PSL_2 of the third priority entry ET3 is ‘1’, the priority manager PM may confirm that the preceding command prior to the read command RCMD with respect to the third cache data CD3 is the prefetch command.

The storage device 20 may receive the read command RCMD with respect to the third cache data CD3. In correspond to the reception, the priority manager PM may determine and update flag bits representing the priority P and the priority setting list correspondences PSL_1 to PSL_M with respect to the third cache data CD3, based on the first priority setting list PSL1 where the preceding command and the following command correspond to ‘the prefetch command-read command’.

As the storage device 20 receives the read command RCMD with respect to the third cache data CD3, the priority manager PM may update each of the priority P and the first priority setting list correspondence PSL_1, and the second priority setting list correspondence PSL_2 to ‘P1’, ‘1’, and ‘0’, respectively, based on the first priority setting list PSL1 and flag bits representing the second priority setting list correspondence PSL_2.

Depending on the embodiment, the priority manager PM may change the priority P of the priority entry whose flag bit of the first priority setting list correspondence PSL_1 is 1, according to the priority value PV change of the first priority setting list PSL1.

In the present disclosure, the cache controller 2145_1 may improve the flexibility and hit ratio of a cache replacement policy by comprehensively consider the state of cache data, by determining and storing the priority with respect to the cache data, through the priority setting lists PSL1 to PSLM distinguished based on the type of command and the sequence of the type of command.

In the present disclosure, the processor 213 and the cache controller 2145_1 may optimize the cache hit ratio with respect to the user data according to the system operating state, by variably setting the priority of cache data according to the operation situation of the host device 10.

The priority manager PM may update the priority P with respect to the first cache data CD1 of the first priority entry ET1 from ‘P0’ to ‘P1’.

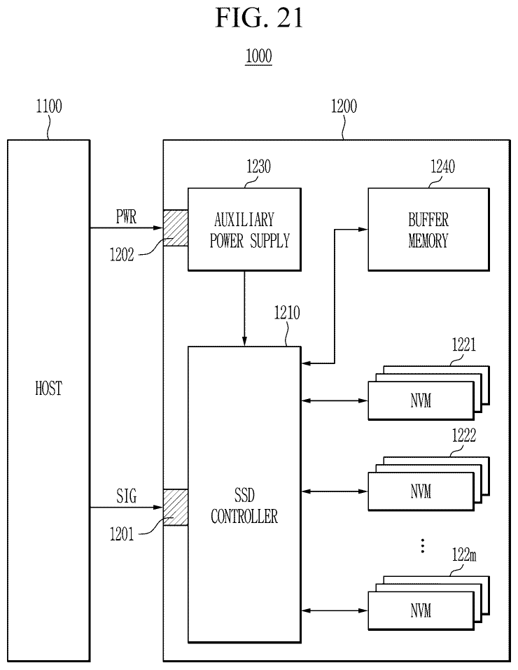

FIG. 21 is a block diagram showing an SSD system applied with a storage device according to an embodiment. Referring to FIG. 21, SSD system 1000 may include a host 1100 and an SSD 1200.

The SSD 1200 may exchange a signal SIG with the host 1100 through the signal connector 1201, and receive power PWR through the power connector 1202. The SSD 1200 may include an SSD controller 1210, a plurality of flash memories 1221 to 122m, an auxiliary power supply 1230, and a buffer memory 1240. The plurality of flash memories 1221 to 122m may be connected the SSD controller 1210 through plurality of channels, respectively.

The SSD controller 1210 may control the plurality of flash memories 1221 to 122m in response to the signal SIG received from the host 1100. The SSD controller 1210 may store a signal generated internally or transmitted from the outside (e.g., the signal SIG received from the host 1100) in the buffer memory 1240.

The SSD controller 1210 may be implemented as the storage controller 200 described above with reference to FIG. 1 to FIG. 20. For example, the SSD controller 1210 may include a cache memory that distinguishes priority of the replacement operation based on the type of command and the sequence of the type of command, and thereby improve the flexibility and hit ratio of a cache replacement policy within the SSD controller 1210. In addition, the cache memory of the SSD controller 1210 may variably set the priority of cache data according to the operation situation of the host 1100 to optimize the cache hit ratio with respect to the user data according to the system operating state, and may improve the overall input/output performance of the SSD 1200.

The plurality of flash memories 1221 to 122m may operate under the control of the SSD controller 1210. The auxiliary power supply 1230 is connected to the host 1100 through the power connector 1202.

The auxiliary power supply 1230 may be connected to the host 1100 through the power connector 1202. The auxiliary power supply 1230 may receive the power PWR from the host 1100, and be charged thereby. When the power supply from the host 1100 is not smooth, the auxiliary power supply 1230 may provide the power of the SSD 1200.

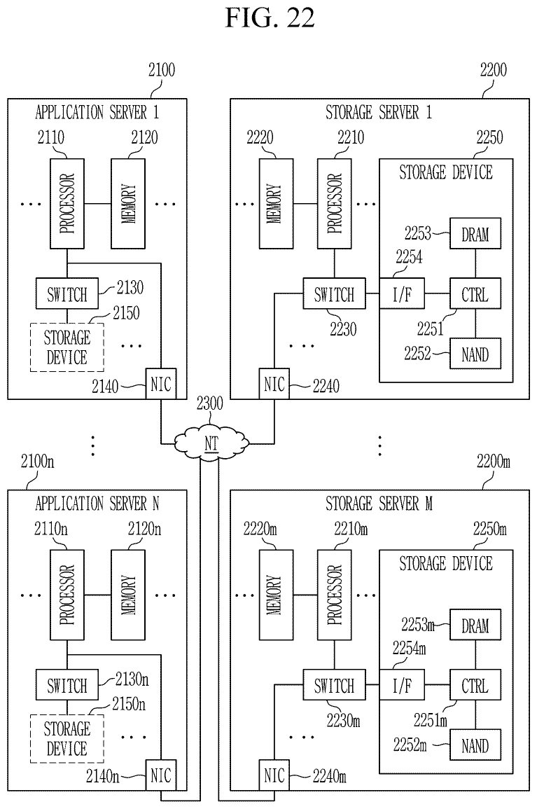

FIG. 22 is a block diagram showing a data center applied with a storage device according to an embodiment. Referring to FIG. 22, a network system 2000 is a facility that collects various data and provides services, and may be referred to as a data center or a data storage center. The network system 2000 may include application servers 2100 to 2100n and storage servers 2200 to 2200m, and the application servers 2100 to 2100n and the storage servers 2200 to 2200m may be referred to as computing nodes. Depending on the embodiment, the number of the application servers 2100 to 2100n and the number of the storage servers 2200 to 2200m may be selected in various ways, and the number of the application servers 2100 to 2100n and the number of the storage servers 2200 to 2200m may be different from each other.

The application servers 2100 to 2100n and the storage servers 2200 to 2200m may communicate with each other through a network 2300. The network 2300 may be implemented by using Fibre Channel (FC), ethernet, or the like. At this time, FC is a medium used for high-speed data transmission, and may use an optical switch providing high performance and/or high availability. Depending on the access method of the network 2300, the storage servers 2200 to 2200m may be provided as a file storage, a block storage, or an object storage.

In an embodiment, the network 2300 may be a network dedicated for storage, such as a storage area network (SAN). For example, the SAN may be an FC-SAN that uses a FC network and is implemented according to a FC Protocol (FCP). In an embodiment, the SAN may be an IP-SAN using a TCP/IP network and implemented according to the iSCSI(SCSI over TCP/IP or Internet SCSI) protocol. In an embodiment, the network 2300 may be a general network, such as a TCP/IP network. For example, the network 2300 may be implemented according to protocols such as FC over Ethernet (FCoE), network attached storage (NAS), and NVMe over Fabrics (NVMe-oF).

Hereinafter, the description will focus on an application server 2100 and a storage server 2200. Description of the application server 2100 may also be applied to another application server 2100n, and description of the storage server 2200 may also be applied to another storage server 2200m.

The application server 2100 may include a processor 2110 and a memory 2120. The processor 2110 may control an overall operation of the application server 2100, and may access the memory 2120 to execute commands and/or data loaded in the memory 2120. Depending on the embodiment, the number of the processor 2110 and the number of the memory 2120 included in the application server 2100 may be selected in various ways. In an embodiment, the processor 2110 and the memory 2120 may be configured as a processor-memory pair. In an embodiment, the numbers of the processor 2110 and the memory 2120 may be set different from each other.

The application server 2100 may further include a storage device 2150. At this time, the number of the storage device 2150 included in the application server 2100 may be selected in various ways depending on the embodiment. The processor 2110 may provide command to the storage device 2150, and the storage device 2150 may operate in response to the command received from the processor 2110. However, the present disclosure is not limited thereto, and the application server 2100 may not include the storage device 2150.

The application server 2100 may further include a switch 2130 and network interface card (NIC) 2140. Under the control of the processor 2110, the switch 2130 may selectively connect the processor 2110 and the storage device 2150 or selectively connect the NIC 2140 and the storage device 2150. The NIC 2140 may include a wired interface, a wireless interface, a Bluetooth interface, an optical interface, and the like. In an embodiment, the processor 2110 and the NIC 2140 may be integrated into one. In an embodiment, the storage device 2150 and the NIC 2140 may be integrated into one.

The application server 2100 may store data, requested to be stored by a user or client, in one of the storage servers 2200 to 2200m through the network 2300. In addition, the application server 2100 may obtain the data requested to be read by a user or client from one of the storage servers 2200 to 2200m through the network 2300. For example, the application server 2100 may be implemented as a web server or database management system (DBMS), or the like.

The application server 2100 may access a memory 2120n or a storage device 2150n included in another application server 2100n through the network 2300, and/or may access memories 2220 and 2220m or storage devices 2250 and 2250m included in storage servers 2200 and 2200m through the network 2300. Accordingly, the application server 2100 may perform various operations with respect to data stored in the application servers 2100 and 2100n and/or the storage servers 2200 and 2200m. For example, the application server 2100 may execute a command to move or copy data between the application servers 2100 and 2100n and/or the storage servers 2200 and 2200m. In this case, data may be moved through the network 2300 in an encrypted state for security or privacy.

The storage server 2200 may include a processor 2210 and a memory 2220. The processor 2210 may control an overall operation of the storage server 2200, and may access the memory 2220 to execute commands and/or data loaded in the memory 2220. Depending on the embodiment, the number of the processor 2210 and the number of the memory 2220 included in the storage server 2200 may be selected in various ways. In an embodiment, the processor 2210 and the memory 2220 may be configured as a processor-memory pair. In an embodiment, the numbers of the processor 2210 and the memory 2220 may be set different from each other.

The processor 2210 may include single core processor or multi-core processor. For example, the processor 2210 may include a general-purpose processor, a central processing unit (CPU), a graphics processing unit (GPU), a digital signal processor (DSP), a microcontroller (MCU), a microprocessor, a network processor, an embedded processor, a field programmable gate array (FPGA), an application-specific instruction set processor (ASIP), an application-specific integrated circuit processor (ASIC), or the like.

The storage server 2200 may further include at least one storage device 2250. The number of the storage device 2250 included in the storage server 2200 may be selected in various ways, depending on the embodiment. The storage device 2250 may include a controller (CTRL) 2251, a NAND flash (NAND) 2252, a DRAM 2253, and interface (I/F) 2254. Hereinafter, the configuration and operation of the storage device 2250 will be described in detail. The following description of the storage device 2250 may also be applied to other storage devices 2150, 2150n, and 2250m.

An interface 2254 may provide a physical connection between the processor 2210 and a controller 2251 and a physical connection between a NIC 2240 and the controller 2251. For example, the interface 2254 may be implemented in a direct attached storage (DAS) method that directly connects the storage device 2250 with a dedicated cable. In addition, for example, the interface 2254 may be implemented in various interface methods such as advanced technology attachment (ATA), serial ATA (SATA), external SATA (e-SATA), Small Computer Small Interface (SCSI), a Serial Attached SCSI (SAS), Peripheral Component Interconnection (PCI), PCI express (PCIe), NVM express (NVMe), IEEE 1394, universal serial bus (USB), secure digital (SD) card, multi-media card (MMC), embedded multi-media card (eMMC), compact flash (CF) card interface, or the like.

The controller 2251 may generally control the operation of the storage device 2250. The controller 2251 may program data into the NAND flash 2252 in response to a program command, or may read data from the NAND flash 2252 in response to the read command. For example, the program command and/or the read command may be sent from processor 2210 in storage server 2200, a processor 2210m in another storage server 2200m, or processor 2110 and 2110n in the application servers 2100 and 2100n, through the processor 2210 or directly.

The NAND flash 2252 may include a plurality of NAND flash memory cells. However, embodiments of the present disclosure are not limited thereto, and the storage device 2250 may include a non-volatile memory other than the NAND flash 2252, for example, resistive RAM (ReRAM), phase change RAM (PRAM), or magnetic RAM (MRAM), or may include magnetic storage media or optical storage media.

The dynamic RAM (DRAM) 2253 may be used as a buffer memory. For example, the DRAM 2253 may be double data rate synchronous DRAM (DDR SDRAM), low-power DDR (LPDDR) SDRAM, graphics DDR (GDDR) SDRAM, Rambus DRAM (RDRAM) or high-bandwidth memory (HBM). However, embodiments of the present disclosure are not limited thereto, and the storage device 2250 may use a volatile memory or non-volatile memory other than the DRAM as a buffer memory. The DRAM 2253 may temporarily store (buffer) data to be written to the NAND flash 2252 or data read from the NAND flash 2252.

The storage server 2200 may further include a switch 2230 and the NIC 2240. Under the control of the processor 2210, the switch 2230 may selectively connect the processor 2210 and the storage device 2250, or may selectively connect the NIC 2240 and the storage device 2250. In an embodiment, the processor 2210 and the NIC 2240 may be integrated into one. In an embodiment, the storage device 2250 and the NIC 2240 may be integrated into one.

Storage devices 2150, 2150n, 2250, and 2250m may correspond to the storage device described above with reference to FIG. 1 to FIG. 20. For example, the controller 2251 may transfer command/address CMD/ADDR to the NAND flash 2252, upon request provided from one of the processors 2110, 2110n, 2210, and 2210m. The controller 2251 may include a cache memory that distinguishes priority of the replacement operation based on a type of the command CMD and a sequence of the type of the command, and thereby may improve the flexibility and hit ratio of a cache replacement policy within the controller 2251. In addition, the cache memory of the controller 2251 may variably set the priority of cache data according to the operation situation of the host device 10 to optimize the cache hit ratio with respect to the user data according to the system operating state, and thereby may improve the overall input/output performance of the storage devices 2150, 2150n, 2250, and 2250m.

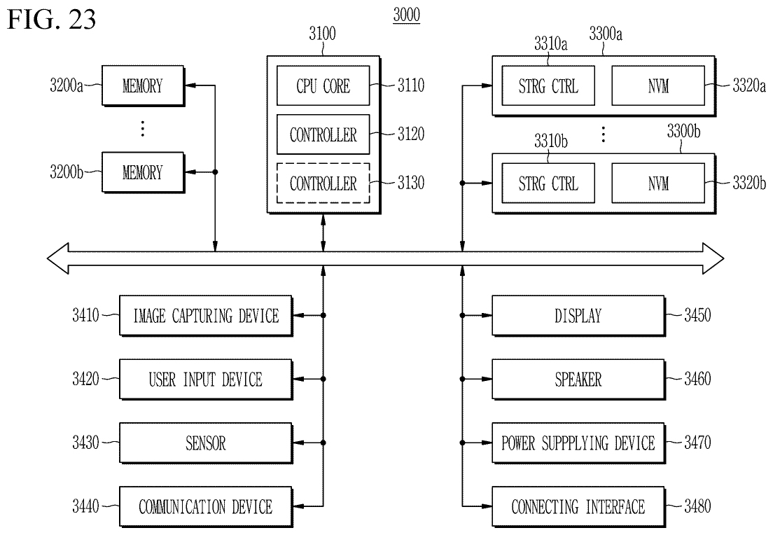

FIG. 23 is a block diagram showing an electronic system applied with a storage device according to an embodiment. Referring to FIG. 23, basically, the system 1500 may be a mobile system such as a portable communication terminal (e.g., mobile phone), a smart phone, a tablet PC (tablet personal computer), a wearable device, a healthcare device, or an internet of things (IOT) device. In an embodiment, the system 3000 is not necessarily limited to a mobile system, and may be an personal computer, a laptop computer, a server, a media player, an automotive device such as navigation, or the like.

The system 3000 may include a main a processor 3100, memories 3200a and 3200b and storage devices 3300a and 3300b, and additionally, may include at least one of an image capturing device 3410, a user input device 3420, a sensor 3430, a communication device 3440, a display 3450, a speaker 3460, a power supply device 3470, and a connecting interface 3480.

A main processor 3100 may control an overall operation of the system 3000, more specifically, operations of other components forming the system 3000. The main processor 3100 may be implemented as a general-purpose processor, a dedicated processor, an application processor, or the like. It may correspond to the host processor 11 of FIG. 1.

The main processor 3100 may include one or more CPU cores 3110, and may further include a controller 3120 for controlling the memories 3200a and 3200b and/or the storage devices 3300a and 3300b. Depending on the embodiment, the main processor 3100 may further include an accelerator 3130, which is a dedicated circuit for high-speed data calculation, such as artificial intelligence (AI) data calculation. The accelerator 3130 may include a graphics processing unit (GPU), a neural processing unit (NPU), a data processing unit (DPU), and/or the like, and may be implemented as a chip physically independent and separate from other components of the main processor 3100.

The memories 3200a and 3200b may be used as a main memory device of the system 3000, may include a volatile memory such as SRAM and/or DRAM, but may also include a non-volatile memory such as a flash memory, PRAM, RRAM, and/or the like. The memories 3200a and 3200b may also be implemented in the same package as the main processor 3100. In an embodiment, memories 1200a and 1200b may operate as the host memory 12 previously described in FIG. 1.

The storage devices 3300a and 3300b may function as a non-volatile storage device storing data, regardless of whether power is supplied, and may have a relatively large storage capacity compared to the memories 3200a and 3200b. The storage devices 3300a and 3300b may include storage controllers 3310a and 3310b and non-volatile memories (NVM) 3320a and 3320b storing data under the control of the storage controllers 3310a and 3310b. The non-volatile memories 3320a and 3320b may include a flash memory of a 2D (2-dimensional) structure or a 3D (3-dimensional) V-NAND (vertical NAND) structure may, but may include other types of non-volatile memories such as PRAM, RRAM, and/or the like.

The storage controllers 3310a and 3310b may be implemented as the storage controller 200 described above with reference to FIG. 1 to FIG. 20. For example, the storage controllers 3310a and 3310b may include a cache memory that distinguishes priority of the replacement operation based on the type of command and the sequence of the type of command, and thereby may improve the flexibility and hit ratio of a cache replacement policy within the storage controllers 3310a and 3310b. In addition, the cache memory of the storage controllers 3310a and 3310b may variably set the priority of cache data according to the operation situation of the main processor 3100 to optimize the cache hit ratio with respect to the user data according to the system operating state, and thereby may improve the overall input/output performance of the storage devices 3300a and 3300b.

The storage devices 3300a and 3300b may be included in the system 3000 while being physically separated from the main processor 3100, and may be implemented in the same package as the main processor 3100. In addition, the storage devices 3320a and 3320b may have the form such as a solid-state drive (SSD) or a memory card, and may be detachably attached to other components of the system 3000 through an interface such as the connecting interface 3480 to be described later. The storage devices 3300a and 3300b may be a device applied with a standard protocol such as Universal Flash Storage (UFS), embedded multi-media card (eMMC), or non-volatile memory express (NVMe), but is not necessarily limited thereto.

In an embodiment, under the control of the main processor 3100, the storage devices 3300a and 3300b may be configured to perform various calculations, and in an embodiment, the storage devices 3300a and 3300b may be configured to execute or perform some of functions executed by the accelerator 3130.

The image capturing device 3410 may photograph a still image or a motion picture, and may be a camera, a camcorder, a webcam, and/or the like.

A user input device 3420 may receive various types of data input from the user of the system 3000, and may be a touch pad, a keypad, a keyboard, a mouse, a microphone, and/or the like.

The sensor 3430 may detect various types of physical quantities that may be obtained from the outside of the system 3000, and may convert the detected physical quantities to electrical signals. The sensor 3430 may be a temperature sensor, a pressure sensor, an illumination sensor, a position sensor, an acceleration sensor, a biosensor, a gyroscope sensor, and/or the like.

The communication device 3440 may perform sending and receiving of signals with other devices outside the system 3000 according to various communication protocols. Such a communication device 3440 may be implemented to include an antenna, a transceiver, a modem, and/or the like.

The display 3450 and the speaker 3460 may function as an output device that outputs visual information and auditory information to the user of the system 3000, respectively.

The power supply device 3470 may appropriately convert electrical power supplied from a battery built in the system 3000 and/or an external power source, and supply it to respective components of the system 1000.

The connecting interface 3480 may provide a connection between the system 3000 and an external device connected to the system 3000 and capable of exchanging data with the system 3000. The connecting interface 3480 may be implemented in various interface methods such as advanced technology attachment (ATA), serial ATA (SATA), external SATA (e-SATA), Small Computer Small Interface (SCSI), the Serial Attached SCSI (SAS), Peripheral Component Interconnection (PCI), PCI express (PCIe), NVMe, IEEE 1394, universal serial bus (USB), secure digital (SD) card, multi-media card (MMC), eMMC, UFS, embedded Universal Flash Storage (eUFS), compact flash (CF) card interface, or the like.

While embodiments of the present disclosure have been described in connection with what is presently considered to be practical embodiments, it is to be understood that the disclosure is not limited to the disclosed embodiments, but, on the contrary, is intended to cover various modifications and equivalent arrangements included within the spirit and scope of the appended claims.

What is claimed is:

1. A storage controller comprising:
a processor configured to input and output a command for data to an outside;
a data memory configured to store the data as cache data;
a tag memory configured to store a priority with respect to replacement of the cache data; and
a cache controller configured to determine the priority based on a type of the command with respect to the data stored as the cache data and a sequence of the type.

2. The storage controller of claim 1, wherein the cache controller is further configured to determine the priority with respect to the cache data based on a priority table,
wherein the priority table comprises a priority setting list, and
wherein the priority setting list comprises a preceding command, a following command sequentially generated for one cache data, and a priority value corresponding to a type of the preceding command and a type of the following command.

3. The storage controller of claim 2, wherein the type of the preceding command is one of a read command, a write command, and a prefetch command, and
wherein the type of the following command is one of the read command, the write command, and the prefetch command.

4. The storage controller of claim 3, wherein the cache controller is further configured to update the priority stored in the tag memory based on the priority setting list.

5. The storage controller of claim 2, wherein the type of the preceding command is a vacant command, and
wherein the type of the following command is one of a read command, a write command, and a prefetch command.

6. The storage controller of claim 5, wherein the cache data is newly stored in the data memory, and
wherein the cache controller is further configured to initially set the priority in the tag memory based on the priority setting list.

7. The storage controller of claim 2, wherein the priority setting list comprises a first priority setting list and a second priority setting list that is different from the first priority setting list,
wherein the first priority setting list comprises a first preceding command, a first following command, and a first priority value corresponding to a type of the first preceding command and a type of the first following command,
wherein the second priority setting list comprises a second preceding command, a second following command, and a second priority value corresponding to a type of the second preceding command and a type of the second following command, and
wherein the type of the first following command and the type of the second preceding command are the same.

8. The storage controller of claim 7, wherein the cache controller is further configured to update the priority stored based on the first priority setting list, based on the second priority setting list.

9. The storage controller of claim 8, wherein the tag memory is further configured to store a first index with respect to the first priority setting list together with the priority, and
wherein the cache controller is further configured to update the priority based on the first index and the second priority setting list.

10. The storage controller of claim 1, wherein the data memory is further configured to store the cache data in a full-associative method.

11. The storage controller of claim 10, wherein the data comprises a first data and a second data different from the first data, and
wherein the cache controller is further configured to, based on the first data being stored in the data memory as a first cache data, the second data being stored in a cache memory and the data memory being full, remove the first cache data based on the priority.

12. A storage device comprising:
a non-volatile memory device configured to store data; and
a storage controller comprising a cache memory configured to:
store cache data with respect to the data and a priority with respect to replacement of the cache data, and
change at least a portion of a priority table determining the priority with respect to the cache data, based on an application executed by an external host device.

13. The storage device of claim 12, wherein the cache memory comprises:
a data memory configured to store the cache data;
a tag memory configured to store the priority in a priority bitmap of a bitmap format; and
a cache controller comprising the priority table and configured to determine the priority based on the priority table.

14. The storage device of claim 13, wherein the priority table comprises a first priority setting list comprising a first priority value and a second priority setting list comprising a second priority value, corresponding to a type of a command for the cache data and a sequence of the type, and
wherein the cache controller is further configured to:
set the first priority setting list based on a first special function register (SFR) storing the first priority value, and
set the second priority setting list based on a second SFR storing the second priority value.

15. The storage device of claim 14, wherein the cache data comprises a first cache data and a second cache data different from the first cache data,
wherein the priority bitmap comprises a first entry with respect to the first cache data, and a second entry with respect to the second cache data,
wherein the first entry comprises a first priority with respect to the first cache data, and a first index of at least two bits with respect to the first priority setting list, and
wherein the second entry comprises a second priority with respect to the second cache data, and a second index of at least two bits with respect to the second priority setting list, and comprises the second index.

16. The storage device of claim 15, wherein based on execution of the application, the first priority value stored in the first SFR is changed to a third priority value, and
wherein based on the first SFR storing the third priority value, the first priority within the priority bitmap is changed based on the first index and the third priority value.

17. The storage device of claim 15, wherein, based on execution of the application, the first priority value stored in the first SFR is changed to a third priority value, and
wherein, based on the first SFR storing the third priority value, the first priority and the second priority within the priority bitmap are maintained.

18. The storage device of claim 14, wherein the cache data comprises a first cache data and a second cache data that is different from the first cache data,
wherein the priority bitmap comprises a first entry with respect to the first cache data, and a second entry with respect to the second cache data,
wherein the first entry comprises a first priority with respect to the first cache data, and a first flag bit of one bit with respect to whether the first cache data corresponds to the first priority setting list, and
wherein the second entry comprises a second priority with respect to the second cache data, and a second flag bit of one bit with respect to whether the second cache data corresponds to the first priority setting list.

19. The storage device of claim 12, wherein the cache memory is further configured to change the at least the portion of the priority table based on the application being a front-processed application.

20. A storage system comprising:
a host device configured to execute an application and provide an input/output command with respect to data based on execution of the application; and
a storage device comprising:
a non-volatile memory device configured to store the data according to the input/output command; and
a cache memory configured to:
store the data as cache data,
store a priority with respect to replacement of the cache data, and
determine the priority based on the application, a type of the input/output command for the data stored as the cache data, and a sequence of the type.
